(19) United States
(12) Patent Application Publication
(10) Pub. No.: US 2023/0348233 A1
(43) Pub. Date: Nov. 2, 2023

(54) Upending Elongate Structures Offshore

(71) Applicant: Seaway Heavy Lifting Engineering B.V., Zoetermeer (NL)

(72) Inventors: Arnoldus Lourens Bosch, Gouda (NL); Jeroen Michiel Zwart, Zoetermeer (NL)

(21) Appl. No.: 17/908,855

(22) PCT Filed: Mar. 2, 2021
(86) PCT No.: PCT/EP2021/055216

§ 371 Date: Sep. 1, 2022

(30) Foreign Application Priority Data
Mar. 2, 2020 (GB) 2002993.0

(51) Int. Cl. B63B 35/00; E02D 15/08; B66C 1/16; B66C 13/08; B63B 27/10; E02D 35/00

(52) U.S. Cl. CPC B66C 1/16; B63B 27/10; B63B 35/003; B66C 13/08; E02D 15/08; E02D 35/005

(57) ABSTRACT

A crane (16) for upending an elongate structure such as a monopile (28) supports elongate rigging elements that are connected to the structure at respective connection axes spaced longitudinally along the structure. At least one of those elements, of fixed length (36), extends to a first connection axis and at least one other of those elements, of variable length (34), extends to a second connection axis. A frame (24) suspended from the crane (16) supports a winch (46) that pays out the variable-length element (34) of the rigging to lengthen that element. This lowers the second connection axis relative to the first connection axis, which serves as a pivot axis about which the structure is upended.

This invention relates to the challenges of upending a bulky elongate structure such as a monopile foundation or a jacket structure that is being lifted into a body of water by an installation vessel.

A monopile is a hollow cylindrical column, installed in a vertical orientation, that is commonly used as a foundation for an offshore wind turbine. Typically, installation of a monopile involves transporting it horizontally to an installation site and then upending it by lifting one end using a floating crane. Once vertical, the monopile is driven vertically into the seabed. Sometimes a monopile is transported aboard the vessel that supports the crane; alternatively, the monopile can be transported aboard a separate vessel or barge.

A pivot axis for upending a monopile may be defined on a crane vessel as shown in EP 3517479, where the crane lifts the top end of the monopile while an upend frame on the main deck of the vessel controls the pivoting motion. However, if a monopile is longer than the height that is available between the crane hook and the water surface, transporting and installing the monopile by this conventional method may not be possible. Also, upending over the side of the vessel is restricted by the load capacity of its deck and hull. Consequently, this technique is not suitable for future extra-extra-large (XXL) monopiles that could, for example, weigh about 3000 metric tons.

It is also possible to launch an elongate structure from a vessel, as shown for suction piles in WO 99/64684, but such a method does not allow for fine control of the position and verticality of the pile.

A third installation method involves floating a monopile closed with plugs at its top and bottom ends, hence making the monopile positively buoyant. Upending is done by suspending the top end of monopile from a crane hook and then ballasting the monopile through the bottom plug. This is an example of ballasting an elongate structure to upend it in water by creating differential buoyancy along its length, as also described for a jacket in US RE30823. However, controlling flooding of a structure with ballasting water can be complex and risks uncontrolled sinking. Also, for a monopile, it adds considerable time and expense to manufacture, install and remove the plugs.

More generally, upending of a structure can be performed in air or in water, with the structure suspended between two cranes and/or winches or between two hooks of the same crane.

In EP 2372143, for example, a cable arrangement for upending a pile employs two winches mounted on a self-elevating platform, also known as a ‘jack-up’. The pile swings below the deck of the jack-up, between the legs that support the deck. This renders the teaching of EP 2372143 unsuitable for use with a floating crane vessel, as the pile would clash with the hull of the vessel.

CN 109879182 discloses a crane that supports a pair of winches. A cable of one of the winches is connected to a top end of a pile and a cable of the other winch is connected to a bottom end of the pile. With the crane suspending the pile from the winch cables, opposed movement of the winch cables is then synchronised to raise the top end of the pile while simultaneously lowering the bottom end of the pile. Similarly in CN 202745060, a crane handles the top of a pile while a separate winch handles the bottom of the pile.

Employing a combination of winches and/or cranes in these ways adds risk to the operation because even a slight discrepancy in the control of the two winches and/or cranes could generate excessive tension in either of their cables.

US 2015/0228366 describes a tool for lifting and rotating a shipping container. The tool includes a rigging line that connects to the container at a lifting point and winch cabling that connects to the top of the container. The winch draws in the winch cabling to rotate the container about the lifting point from a horizontal orientation to a vertical orientation.

Upending devices in general are known in the art, for example in DE 102005030969, JP 2011079634, KR 20140004422, CN 107840254, CN 110803609, CN 110217698, CN 108726359, EP 2364949 and WO 2015/014491. EP 3559442 relates to an apparatus for lifting and mounting a wind turbine blade on a wind turbine.

Against this background, the invention resides in a lifting arrangement for upending an elongate structure. The arrangement comprises: rigging of elongate elements that are connected to the structure at respective connection axes spaced longitudinally along the structure, at least one of those elements extending to a first connection axis and at least one other of those elements extending to a second connection axis and being of variable length; and a frame suspended from a crane, the frame supporting at least one winch that acts on the at least one variable-length element of the rigging.

The frame may be suspended via a hoisting system of the crane, for example via a hook of the crane.

Conveniently, the first connection axis may define a pivot axis about which the structure is upended. The at least one element extending to the first connection axis is preferably of substantially fixed length.

In examples to be described, the structure has a pair of connection points on the first connection axis on mutually-opposed sides of the structure, to which respective rigging elements extend. For example, the connection points may be trunnions that protrude from the structure in opposite directions on the first connection axis.

The at least one element extending to the first connection axis may be attached at an opposite end to the frame or directly to the crane.

The centre of gravity of the structure suitably lies in a vertical plane that is disposed between the first and second connection axes. The longitudinal distance along the structure between the second connection axis and that plane is preferably substantially greater than a longitudinal distance along the structure between the first connection axis and that plane. For example, the longitudinal distance between the second connection axis and that plane may be at least five times greater than the longitudinal distance between the first connection axis and that plane.

The or each variable-length element of the rigging may extend from a suspension point of the frame that is offset laterally from the vertical plane containing the centre of gravity of the structure. For example, the suspension point may be offset laterally from that plane by a distance of at least half of a diameter of the structure extending through the second connection axis. That plane may, nevertheless, intersect the winch. For example, the or each variable-length element of the rigging may extend laterally from the winch and over a sheave that defines the laterally-offset suspension point of the frame.

The inventive concept also embraces a corresponding method of upending an elongate structure to an upright orientation. The method comprises: suspending the structure from a crane, for example over water, via elongate rigging elements that are attached to the structure respectively at first and second connection axes spaced longitudinally along the structure; and paying out at least one of the rigging elements from a winch that is also suspended from the crane to lower the second connection axis relative to the first connection axis, hence pivoting the structure around the first connection axis to the upright orientation.

The first connection axis may be held at a substantially fixed height relative to the crane, conveniently by maintaining a rigging element attached to the first connection axis at a substantially fixed length.

Where the winch is suspended from a hook of the crane, the centre of gravity of the structure is preferably kept on a vertical axis that intersects the hook.

A majority of the weight of the structure is preferably borne through the first connection axis, such that less than 20% of the weight of the structure may be borne through the second connection axis.

While upending the structure, the weight of the structure may be transferred from one or more rigging elements attached at the second connection axis to one or more rigging elements attached at the first connection axis. Then, after completing the transfer of weight, the or each rigging element may be detached from the structure at the second connection axis while suspending the weight of the structure from the or each rigging element attached at the first connection axis.

A rigging element suitably extends to the second connection axis from a suspension point that is offset laterally relative to a plane containing the centre of gravity of the structure. Such a suspension point may remain in fixed relation to the winch while upending the structure. Similarly, the second connection axis may be offset radially relative to a longitudinal axis of the structure. In that case, the lateral offset of the suspension point is preferably greater than or equal to the radial offset of the second connection axis.

When the structure is upright, one or more rigging elements preferably extend to the first connection axis substantially in alignment with the centre of gravity of the structure.

The inventive concept also extends to an upending device for use in the lifting arrangement and upending method of the invention. The upending device comprises a frame having at least one lifting point for suspending the frame from a hook of a crane such that a common vertical plane intersects the hook and the frame. The frame comprises: a winch for paying out a rigging element; and a suspension point for supporting the rigging element at a position offset laterally from that vertical plane. The suspension point may, for example, be defined by a sheave spaced laterally from the winch.

The inventive concept also embraces a crane when supporting the upending device of the invention.

Thus, the invention provides an integrated modular spreader bar/winch unit that is defined by and within a truss frame suspended from a crane hook. The purposes of this frame are twofold: firstly to act as a spreader bar to enable upending of a monopile over monopile trunnion lift points that lie beneath the frame and the crane hook; and secondly to act as a modular additional hoist comprising a winch/sheave/hook configuration connected to monopile bottom rigging, for example using a pile hook arrangement.

In this respect, the invention may be implemented in an installation method comprising the following steps:
lifting the monopile from a barge in a horizontal orientation, using trunnions that are close to the centre of gravity of the monopile and a hook at the bottom end of the monopile;
upending the monopile by lowering or extending bottom rigging of the monopile using a winch that is integrated in the spreader frame; and
releasing the hook at the bottom end of the monopile by further lowering the bottom rigging when the monopile is in vertical orientation, leaving the monopile suspended vertically via the trunnions.

The monopile may then be transferred by the crane into a conventional outrigger/gripper attached to the hull of the vessel, whereupon the rigging can be released from the trunnions and the monopile can be driven into the seabed to a final penetration depth.

The invention allows for upending of elongate structures such as monopiles while realising cost reduction through faster offshore operations and improved workability. The invention is suitable for use with XXL monopiles that could weigh as much as 3000 metric tons as noted above.

Specifically, the system of the invention allows lift-off of a monopile or other elongate structure from a deck or barge and upending in a single lift operation. The monopile can be upended perpendicularly to the boom of the vessel crane. Hence, there is no need first to rotate the monopile in line with the crane boom before upending. Upending is easily and reliably controlled by lowering the bottom rigging with a winch while the centre of gravity of the monopile remains directly under the crane hook during both lift-off and upending.

The capacity or power of the winch can be limited as its duty is mainly to lower rather than to raise the load. Another factor that limits the required winch capacity is the location of the trunnions close to the centre of gravity of the monopile. Thus, at least 90% of the weight of the monopile is supported through the trunnions during lift-off and upending, whereas only the remaining weight load of less than 10% of the total is carried through the winch, bottom rigging and pile hook.

The spreader truss frame with the integrated winch is a module that can be suspended from any crane with sufficient capacity, thus providing a modular system that can be transferred between and used on multiple vessels.

Compared to the alternative of floating a monopile before upending it in water, no expensive plugs are required to close the ends of the monopile.

Embodiments of the invention provide a device for upending an elongate, horizontal item, the device comprising: a structure such as a spreader frame to be suspended from the hook of a crane; a rigging arrangement between the structure and a pivot axis of the elongate item; and at least one winch mounted on the structure, the cable of the winch being connected to a point of the elongate item distant from the pivot axis. The cable of the winch may, for example, be connected at the end of the elongate item that will be the bottom end after upending.

The rigging arrangement may comprise at least one sling connected to each side of the elongate item. Conveniently, the rigging arrangement may have constant length.

The winch may be cantilevered so that the cable exits the winch at a distance from the rigging connection substantially equivalent to the radius of the elongate element.

Embodiments of the invention also implement a method for upending an elongate item, the method comprising: suspending a spreader structure from a crane, the spreader structure comprising a winch; arranging rigging between the spreader structure and a pivot axis of the elongate element; connecting the winch cable to an end of the elongate item that will be the lower end after upending; adjusting the paid-out length of the winch cable so that it is tensioned when the elongate element is horizontal; horizontally lifting the elongate element to a pre-determined height; and paying out the winch cable until the elongate element is vertical.

In summary, therefore, the invention adapts a crane to upend an elongate structure such as a monopile. The crane supports, directly or indirectly, elongate rigging elements that are connected to the structure at respective connection axes spaced longitudinally along the structure. At least one of those elements, which may be of fixed length, extends to a first connection axis and at least one other of those elements, which is of variable length, extends to a second connection axis. The centre of gravity of the structure lies on a vertical plane disposed between the connection axes, that plane preferably being much closer to the first connection axis than to the second connection axis.

A frame suspended from the crane supports a winch that pays out the variable-length element of the rigging to lengthen that element. This lowers the second connection axis relative to the first connection axis, the latter therefore serving as a pivot axis about which the structure is upended. Gradually the pivot axis approaches the vertical plane that contains the centre of gravity and eventually lies in that plane, directly over the centre of gravity, when the structure is fully upright.

In order that the invention may be more readily understood, reference will now be made, by way of example, to the accompanying drawings in which:

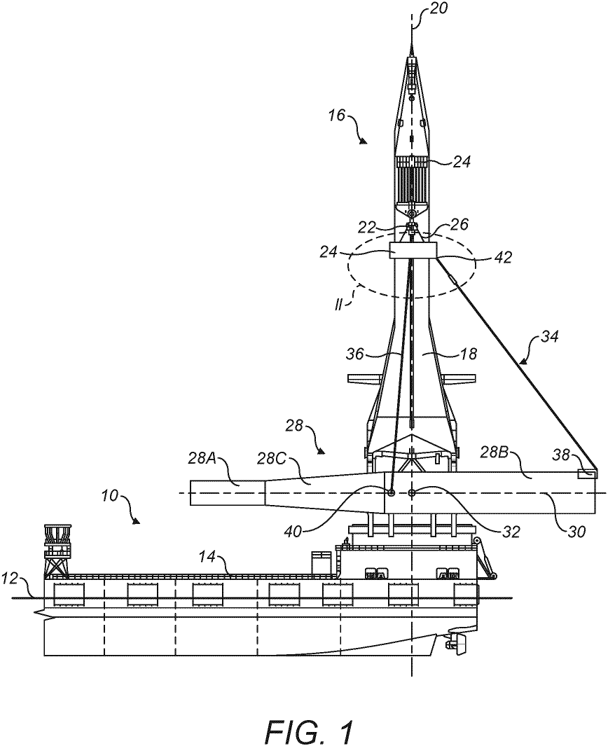

FIG. 1 is a side view of an installation vessel about to upend a monopile that is initially suspended horizontally from a crane of the vessel;

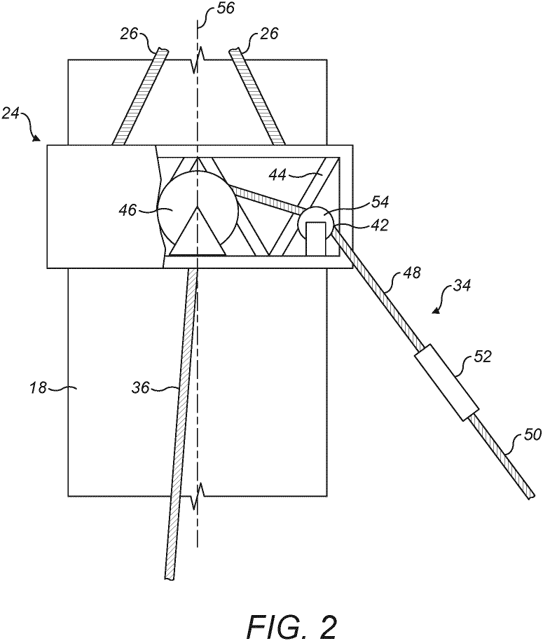

FIG. 2 is an enlarged schematic cut-away view corresponding to Detail II of FIG. 1;

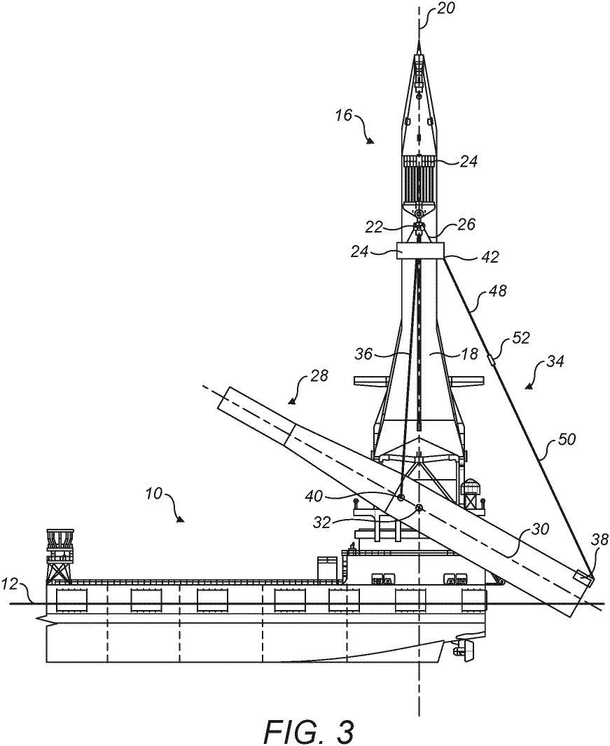

FIG. 3 corresponds to FIG. 1 but shows the monopile partially upended; and

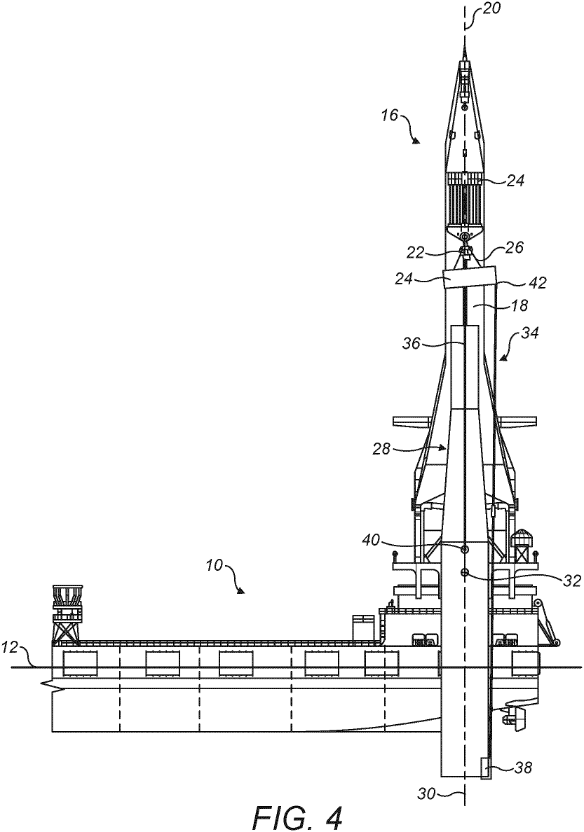

FIG. 4 corresponds to FIGS. 1 and 3 but shows the monopile fully upended.

FIGS. 1, 3 and 4 show an installation vessel 10 floating on the surface 12 of the sea at an installation site. The vessel 10 has a main deck 14 surmounted by a crane 16 whose jib or boom 18 can slew around a vertical slew axis 20. The slew axis 20 and the centreline of the boom 18 both lie on a common vertical plane.

As is conventional, the hoisting system of the crane 16 comprises a main hook 22 that is suspended from an array of sheaves 24 on the boom 18. The main hook 22 also lies on the common vertical plane that contains the slew axis 20 and the centreline of the boom 18.

In accordance with the invention, a horizontally-extending spreader frame 24 is suspended from the crane 16, in particular from the main hook 22 via downwardly-diverging spreader rigging 26 in this example. The spreader frame 24 is shown in detail in FIG. 2.

Via the spreader frame 24, the crane 16 supports an elongate load that is exemplified here by a monopile 28. In this example, the monopile 28 is a hollow tubular structure that is rotationally symmetrical about a central longitudinal axis 30.

The monopile 28 shown in the drawings comprises a relatively narrow top portion 28A and a relatively wide base portion 28B joined by a frusto-conical intermediate portion 28C. Thus, the centre of gravity 32 of the monopile 28 is offset longitudinally along the central longitudinal axis 30 toward the base end of the monopile 28; indeed, in this example, the centre of gravity 32 lies within the enlarged base portion 28B of the monopile 28.

The centre of gravity 32 of the monopile 28 lies directly beneath the main hook 22 of the crane 16, hence lying on the common vertical plane that contains the main hook 22, the slew axis 20 and the centreline of the boom 18.

The monopile 28 is suspended by load rigging that extends from the spreader frame 24 to longitudinally-spaced, horizontally-extending connection axes on the monopile 28. The load rigging comprises three rigging elements, one element 34 being of variable length and the other two elements 36 being of fixed length in this example. One of fixed-length elements 36 is hidden behind the other fixed-length element 34 in the side views of the drawings.

To define one of the connection axes, the variable-length element 34 of the load rigging is fixed by a hook at its lower end to a radially-protruding lifting shoe 38 at one end of the monopile 28, which is the lower or bottom end when the monopile 28 is upended as shown in FIG. 4. The lifting shoe 38 is on an upper side of the monopile 28 when the monopile 28 is in a horizontal orientation. Thus, the lifting shoe 38 lies on a vertical plane that contains the central longitudinal axis 30 of the monopile 28.

The two fixed-length elements 36 of the load rigging comprise slings that are fixed at their lower ends to respective trunnions 40 of the monopile 28. The trunnions 40 are diametrically opposed to each other about the monopile 28 on the other horizontal connection axis, which intersects the central longitudinal axis 30 of the monopile 28. Thus, the connection axis that joins the trunnions 40 is orthogonal to the vertical plane that contains both the central longitudinal axis 30 and the lifting shoe 38 of the monopile 28.

The variable-length element 34 of the load rigging emerges from the spreader frame 24 at a suspension point 42 that is offset laterally from the vertical plane containing the main hook 22, the slew axis 20 and the centreline of the boom 18. The lateral offset of the suspension point 42 from that vertical plane corresponds approximately to the radial offset of the lifting shoe 38 relative to the central longitudinal axis 30 of the monopile 28. Thus, that lateral offset is slightly greater than the outer radius of the base portion 28B of the monopile 28.

As FIG. 2 shows, the spreader frame 24 comprises a truss structure 44 defining a winch platform that supports a winch 46. The variable-length element 34 of the load rigging comprises a wire 48 extending from the winch 46 and a sling 50 that is joined end-to-end to the wire 48 by a sling coupling 52. The sling 50 extends from the sling coupling 52 to the lifting shoe 38 at the bottom end of the monopile 28.

In this example, the laterally-offset suspension point 42 of the spreader frame 24 is defined by a sheave 54 that is offset laterally from the centrally-located winch 46. The wire 48 extending between the winch 46 and the sling coupling 52 passes over the sheave 54. However, in principle, it would be possible instead to offset the winch 46 laterally and to dispense with the sheave 54.

The spreader rigging 26 is fixed to the truss structure 44, arranged symmetrically with respect to the vertical plane 56 that bisects the spreader frame 24 and that also contains the main hook 22, the slew axis 20 and the centreline of the boom 18. The fixed-length elements 36 of the load rigging are also fixed centrally to the truss structure 44.

The monopile 28 is shown in FIG. 1 in a horizontal orientation, suspended over the side of the vessel 10 above the surface 12, having been lifted in that orientation from a barge (not shown) on which the monopile 28 was transported to the installation site. The clearance between the monopile 28 and the surface 12 ensures that the monopile 28 is not directly subject to wave action at this initial stage.

As the centre of gravity 32 lies between the trunnions 40 and the lifting shoe 38 at the bottom end of the monopile 28, the weight of the monopile 28 is shared between the elements 34, 36 of the load rigging, which are therefore all in tension. However, as the centre of gravity 32 is much closer to the trunnions 40 than to the lifting shoe 38, the vast majority (about 90%) of the weight of the monopile 28 is borne by the fixed-length elements 36 of the load rigging and the remainder (hence only about 10%) is borne by the variable-length element 34 of the load rigging. The winch 46 of the spreader frame 24 that acts against the tension in the variable-length element 34 therefore needs only to have a correspondingly small capacity.

FIG. 3 shows the upending operation in progress. It will be apparent that by paying out the wire 48 from the winch 46 and hence lengthening the variable-length element 34 of the load rigging, the bottom end of the monopile 28 is lowered relative to the trunnions 40. Thus, the monopile 28 tilts toward being upright.

The trunnions 40 remain at a substantially unchanged height above the surface 12 by virtue of the fixed-length elements 36 of the load rigging and so define a nearly-fixed pivot axis as the monopile 28 tilts away from the horizontal. The trunnions 40, suspended on the fixed-length elements 36, merely swing slightly toward the vertical plane that contains the main hook 22, the slew axis 20 and the centreline of the boom 18. This minor movement of the trunnions 40 allows the centre of gravity 32 of the tilting monopile 28 to remain on that vertical plane.

FIG. 4 shows the upending operation now completed after paying out more of the wire 48 from the winch 46, further to lengthen the variable-length element 34 of the load rigging and hence further to pivot the monopile 28 about the trunnions 40. The monopile 28 is now upright, with its central longitudinal axis 30 substantially vertical and in the vertical plane that contains the main hook 22, the slew axis 20 and the centreline of the boom 18. The trunnions 40 and the fixed-length elements 36 of the load rigging also now lie on that vertical plane, directly above and aligned with the centre of gravity 32 of the monopile 28.

When the monopile 28 is vertical as shown in FIG. 4, the variable-length element 34 of the load rigging is also close to vertical but is offset laterally from the vertical plane that contains the main hook 22, the slew axis 20 and the centreline of the boom 18. The lateral offset of the variable-length element 34 is determined by the lateral offset of the suspension point 42 defined by the sheave 54 of the spreader frame 24, and also by the radial offset of the lifting shoe 38 relative to the central longitudinal axis 30 of the monopile 28. In practice, the variable-length element 34 need not be perfectly vertical at this stage and may, conveniently, converge downwardly toward the plane of the fixed-length elements 36 as shown in FIG. 4.

As the monopile 28 reaches verticality, all of its weight is supported by the fixed-length elements 36 of the load rigging via the trunnions 40. Thus, the minor portion of the weight load supported by the variable-length element 34 is transferred progressively to the fixed-length elements 36. When the variable-length element 34 is no longer under tension, it can be detached from the lifting shoe 38. This allows the crane 16 to transfer the upright monopile 28 into a conventional outrigger/gripper of the vessel 10 to be driven into the seabed as noted previously.

FIG. 4 shows that the spreader frame 24 can tilt relative to the boom 18 of the crane 16 as may be required to balance the system.

In the orientations shown in FIGS. 3 and 4, the bottom end of the monopile 28 is submerged beneath the surface 12. However, partial submergence of the monopile 28 in this manner is not essential: in principle, with a shorter monopile 28 and/or a higher crane hook 22 or shorter rigging, uprighting could be performed entirely in air.

Other variations are possible within the inventive concept. For example, the fixed-length elements of the load rigging could be attached directly to the main hook of the crane and not via the spreader frame.

The load rigging could comprise more than one variable-length element or any number of fixed-length elements.

It is not essential that a variable-length rigging element is attached to an end of the structure being upended. The variable-length rigging element could instead be attached to the structure at a connection point inboard from its end.

The structure could be lowered into or onto the water in a horizontal orientation and then upended by paying out a variable-length rigging element. In that case, a lower end of the structure may be flooded with ballasting water either through an open end or a bottom plug.

In a broad sense, all elements of the load rigging could be of variable length, with the spreader frame supporting two or more winches acting on respective elements. However, it is preferred that a majority of the weight of the structure being upended is suspended from fixed-length rigging, which defines a pivot axis for the structure to be upended under the control of variable-length rigging that supports a minority of the weight of the structure.

1. A lifting arrangement for upending an elongate structure, the arrangement comprising:
rigging of elongate elements that are connected to the structure at respective connection axes spaced longitudinally along the structure, at least one of those elements extending to a first connection axis and at least one other of those elements extending to a second connection axis and being of variable length, wherein the structure has a centre of gravity that lies in a vertical plane disposed between the first and second connection axes; and
a frame suspended from a crane, the frame supporting at least one winch that acts on the at least one variable-length element of the rigging;
wherein the at least one variable-length element of the rigging extends laterally from the winch and over a sheave that defines a suspension point of the frame that is offset laterally from said vertical plane, and said vertical plane intersects the winch.

2. The arrangement of claim 1, wherein the frame is suspended via a hoisting system of the crane.

3. The arrangement of claim 2, wherein the frame is suspended via a hook of the crane.

4. The arrangement of any preceding claim, wherein the first connection axis defines a pivot axis about which the structure is upended.

5. The arrangement of any preceding claim, wherein the structure has a pair of connection points on the first connection axis on mutually-opposed sides of the structure, to which respective rigging elements extend.

6. The arrangement of claim 5, wherein the connection points are trunnions that protrude from the structure on the first connection axis.

7. The arrangement of any preceding claim, wherein the at least one element extending to the first connection axis is of substantially fixed length.

8. The arrangement of any preceding claim, wherein the at least one element extending to the first connection axis is attached at an opposite end to the frame.

9. The arrangement of any of claims 1 to 7, wherein the at least one element extending to the first connection axis is attached at an opposite end to the crane.

10. The arrangement of any preceding claim, wherein a longitudinal distance along the structure between the second connection axis and said plane is greater than a longitudinal distance along the structure between the first connection axis and said plane.

11. The arrangement of claim 10, wherein the longitudinal distance between the second connection axis and said plane is at least five times greater than the longitudinal distance between the first connection axis and said plane.

12. The arrangement of any preceding claim, wherein the suspension point is offset laterally from said plane by a distance of at least half of a diameter of the structure extending through the second connection axis.

13. The arrangement of any preceding claim, wherein the structure is suspended by the crane over water.

14. A method of upending an elongate structure to an upright orientation, the method comprising:
suspending the structure from a crane via elongate rigging elements that are attached to the structure respectively at first and second connection axes spaced longitudinally along the structure, at least one of the rigging elements extending over a sheave that defines a suspension point offset laterally relative to a vertical plane containing the centre of gravity of the structure; and
by paying out said at least one of the rigging elements from a winch that is also suspended from the crane and that is intersected by said vertical plane, lowering the second connection axis relative to the first connection axis, hence pivoting the structure around the first connection axis to the upright orientation.

15. The method of claim 14, comprising holding the first connection axis at a substantially fixed height relative to the crane.

16. The method of claim 15, comprising maintaining a rigging element attached to the first connection axis at a substantially fixed length.

17. The method of any of claims 14 to 16, comprising suspending the winch from a hoisting system of the crane.

18. The method of claim 17, comprising suspending the winch from a hook of the crane.

19. The method of claim 18, comprising keeping the centre of gravity of the structure on a vertical axis that intersects the hook.

20. The method of any of claims 14 to 19, comprising bearing a majority of the weight of the structure through the first connection axis.

21. The method of claim 20, comprising bearing less than 20% of the weight of the structure through the second connection axis.

22. The method of any of claims 14 to 21, comprising, while upending the structure, transferring the weight of the structure from one or more rigging elements attached at the second connection axis to one or more rigging elements attached at the first connection axis.

23. The method of claim 22, comprising, after completing said transfer of weight, detaching the or each rigging element from the structure at the second connection axis while suspending the weight of the structure from the or each rigging element attached at the first connection axis.

24. The method of any of claims 14 to 23, wherein the second connection axis is offset radially relative to a longitudinal axis of the structure.

25. The method of claim 24, wherein said lateral offset of the suspension point is at least as great as said radial offset of the second connection axis.

26. The method of any of claims 14 to 25, wherein the suspension point remains in fixed relation to the winch while upending the structure.

27. The method of any of claims 14 to 26, wherein, when the structure is upright, one or more rigging elements extend to the first connection axis substantially in alignment with the centre of gravity of the structure.

28. An upending device, comprising:
a frame having at least one lifting point for suspending the frame from a hook of a crane such that a common vertical plane intersects the hook and the frame, wherein the frame comprises:
a winch for paying out a rigging element, wherein said vertical plane intersects the winch; and
a suspension point for supporting the rigging element at a position offset laterally from said vertical plane.

29. The upending device of claim 28, wherein the suspension point is defined by a sheave spaced laterally from the winch.

30. A crane supporting the upending device of claim 28 or claim 29.
